(19) United States
(12) Patent Application Publication
(10) Pub. No.: US 2013/0108068 A1
(43) Pub. Date: May 2, 2013

(54) HEADSET WITH TWO-WAY MULTIPLEXED COMMUNICATION

(71) Applicants: Jens Kristian Poulsen, Kitchener (CA); Mohamad El-Hage, Cambridge (CA); Robert James Lowles, Waterloo (CA)

(72) Inventors: Jens Kristian Poulsen, Kitchener (CA); Mohamad El-Hage, Cambridge (CA); Robert James Lowles, Waterloo (CA)

(73) Assignee: RESEARCH IN MOTION LIMITED, Waterloo (CA)

(21) Appl. No.: 13/282,577

(22) Filed: Oct. 27, 2011

(51) Int. Cl. H04R 1/10

(52) U.S. Cl. 381/74

(57) ABSTRACT

An advanced headset is provided to enable two-way communication between a portable electronic device to the headset; a slave device located within the headset to receive and process the data; and at least one audio output device to transmit the data to a user. A method for transmitting data from a portable electronic device to a headset having a master device initialize a synchronization mechanism, transmitting the synchronization mechanism to a slave device within the digital headset via a bus, transmitting the data between the master device and slave device, and outputting the data as acoustic signals through an output device. The slave device may contain one or more speakers, controlled by one or more speaker amplifiers. The slave device may contain digital active noise cancellation, beam forming or audio enhanced circuits.

### FIELD

The present disclosure relates generally to headsets. More particularly, the present disclosure relates to digital headsets.

### BACKGROUND

As more and more people have access to portable electronic devices such as mobile communication devices, personal digital assistants (PDAs), mobile DVD players, or music players, there has been an increase in the number of accessories that complement these devices. With several jurisdictions now implementing hands-free rules and regulations with respect to using a mobile communication device while driving, headsets are becoming a commonplace accessory.

Headsets should be light and comfortable for a user but as more processing power and functionality is added, headsets may become larger and more cumbersome. Further, headsets requiring their own power source to operate may need a user to replace the entire headset if the power source is not replaceable or may require the user to carry replacements batteries or re-charge the batteries. Further, as a conventional headphone jack has only three to four connectors there is a limited number of signals and wires that can be processed through the headset. One terminal wire will normally be allocated as ground connection and the other terminals used to convey information. When analog low frequency signals are used, one wire is needed for every signal that is to be communicated limiting the function to at most three analog signals (e.g. left/right/microphone or left/right/video).

### BRIEF DESCRIPTION OF THE DRAWINGS

Embodiments of the headset will now be described, by way of example only, with reference to the attached Figures, wherein:

FIG. 1 is a schematic circuit diagram of a headset according to one embodiment;

FIG. 2 illustrates a schematic circuit diagram of the headset according to another embodiment;

FIG. 3 is a schematic circuit diagram of another embodiment of the headset;

FIG. 4 illustrates another schematic circuit diagram according to another embodiment of the headset;

FIG. 5 illustrates a synchronization pattern for use by a headset;

FIG. 6 is a flowchart of a method for processing and transferring signals to and from a digital headset; and

FIG. 7 is a flowchart of a method for adjusting headset sensitivity.

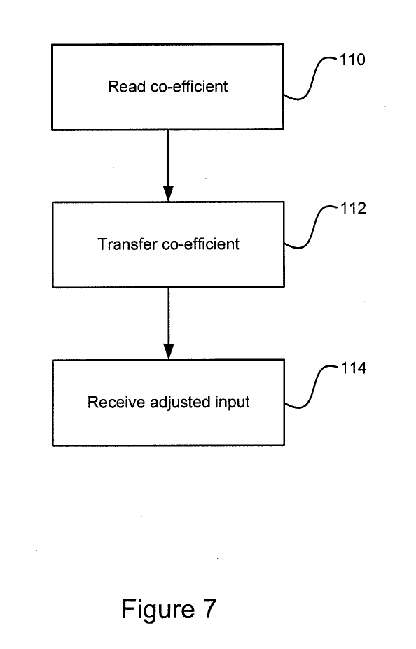

### DETAILED DESCRIPTION

There is provided a headset for use with a portable electronic device, such as a mobile communication device. Due to the constraints on the number of wires within a headset, it is beneficial to multiplex information in order to increase the functionality without adding extra wires. This may also be used to provide digital information between the portable electronic device and the headset where it may be possible to use digital or analog modulation in order to be able to multiplex information in the time or frequency domain. The communication channel can then be used to set up a headset with special parameters for custom tuning or to enable full digital audio to the headset. This may also provide high audio quality and provide a secure communication channel.

In one embodiment, a headset includes the capability to multiplex information on a least one wire using either amplitude, frequency or phase modulation. In another embodiment, the headset may be able to send and receive digital audio signals through a bus, allowing other channels to remain free and allowing for two-way communication. By using digital communication it is possible to place audio circuitry near the transducer elements thereby enabling higher audio quality. It is also possible to include digital signal processing inside the headset for increased functionality such as active noise cancellation. Another advantage is that the digital headset may be able to receive, store and transmit headset parameters and control information in order to be able to adjust sound playback level at certain levels or to assist in optimal audio tuning of the portable electronic device. In yet another embodiment, a digital rights management device is integrated inside the headset, preventing the copying of restricted material.

In a first aspect, a digital headset is provided having a bus to transmit data from a portable electronic device to the headset; at least one slave device located within the headset to receive and process the data; and at least one audio output device to transmit the data to a user.

In a further embodiment, there is provided a digital headset comprising at least one microphone.

In another aspect there is provided a method for transmitting data from a portable electronic device to a headset having a master device that initializes the bus with a synchronization pattern, transmitting the synchronization pattern to at least one slave device within the digital headset via a bus, transmitting the audio and or control data between the master device and the at least one slave device, and inputting or outputting the data as acoustic signals through one or more transducers.

Generally, there is provided a digital headset and a method and system for processing and transferring signals between a digital headset and an associated portable electronic device. In some cases, the headset includes a jack which is inserted into a corresponding port of the associated portable electronic device to facilitate communication between the headset and the portable device. This communication may include, but is not limited to, signals relating to audio, power or instructions. Within the portable electronic device is a set of transducers which convert one type of energy to another or may be used as a sensor or detector or both. In order to provide connectivity between the headset and the transducers, a digital signal connection can be used. The input and output signals from the plurality of transducers can be converted to or from a digital format and be transmitted by using a bus system, for example, a single wire bus or single wire digital bus. Those signals may also be multiplexed. By using this approach, signals can be transmitted over a lower number of wires compared to current solutions. Furthermore, it may be advantageous to simplify this connection between the headset and the portable device as much as possible in order to reduce cost and robustness.

In some embodiments, two-way communication may also be established using frequency or phase modulation in one or more frequency bands outside the audible range. This can be used to monitor key presses, receive or send custom filter co-efficients to or from the headset. The frequencies used would normally be outside the normal audio range (20-20 kHz) in order to be inaudible.

The headset may receive and process multiple sound streams over a digital bus using one or more of the signal wires. In some embodiments, the advanced headset is able to both process digital and analog signals using the headset jack for connection. In another embodiment, the headset uses frequency modulation to receive or set information inside the headset such as filter coefficients as will be described below.

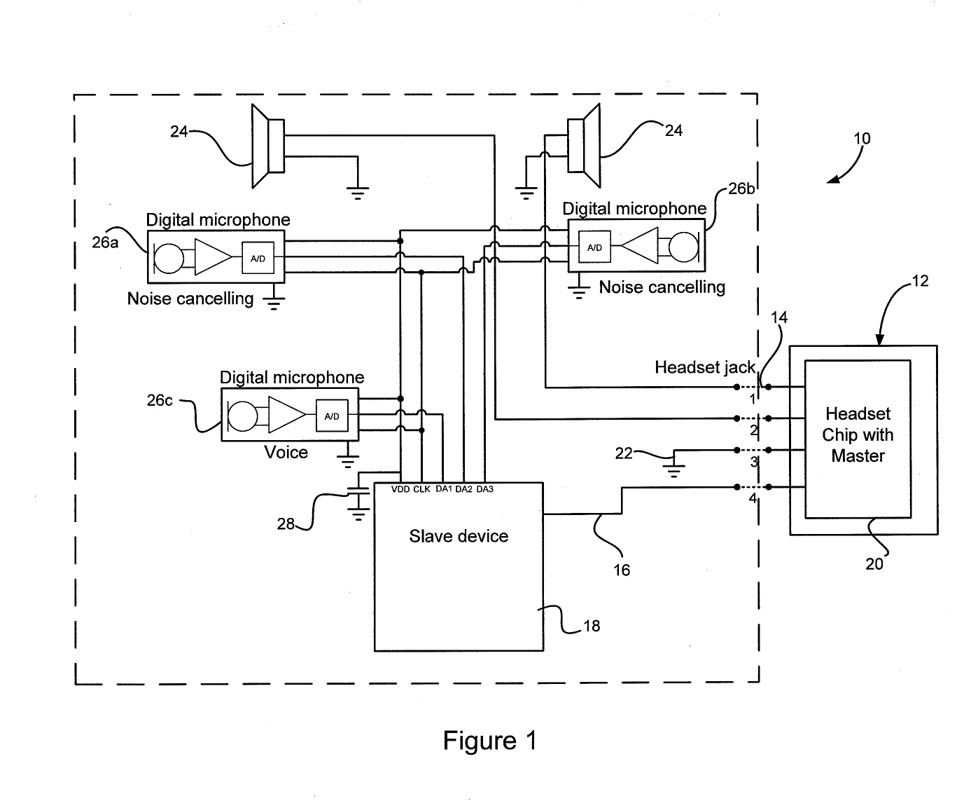

FIG. 1 illustrates a schematic circuit diagram of a digital headset 10 with a connecting apparatus 14, such as a headset jack, allowing for the attachment of the digital headset to a portable electronic device 12. As shown, the headset jack includes a set of four wires although any number of wires may be contemplated. The headset 10 further comprises a set of audio output devices, such as speakers or earphones 24, and a set of digital microphones 26, seen as digital microphones 26a, 26b and 26c. Each individual earphone 24a and 24b is connected to the portable device 12 via the connecting apparatus 14. The digital microphones 26 are connected to a slave device 18 within the headset 10. The slave device 18 may be a processor which controls or monitors the signals received by the microphones 26. In one embodiment, two of the microphones 26a and 26b may be used for noise cancellation while the third microphone 26c may be used for receiving voice, or audio input.

From this figure, it may be seen that the headset 10 is able to communicate with the portable electronic device 12 over a bus 16 such as a single wire bus in a time or frequency domain. The bus 16 may allow for the multiplexing of digital information such as clock, data and power on a single wire and may allow for two-way communication of audio and control data. In one embodiment, the single wire bus may allow for the combination of clock and data, for example, by having one edge (for example, the rising edge) define the clock signal, while the other edge (for example, the falling edge) defines the level for the data. This may be performed in either a time or frequency domain. Alternatively, the digital audio data may be communicated by the bus over multiple wires. The bus 16 may transmit data between a master device 20 within the portable electronic device 12 and the slave device 18 located within the headset 10. For example, the slave device 18 may transmit data such as audio input captured by the microphone to the master device 20 for processing and then receive the processed data via the bus 16 or the processed data may be received at the earphones 24 or speakers. The master device 20 and slave device 18 are discussed in greater detail below. (It may be mentioned at the outset that the “master” and “slave” terminology connotes a primary and secondary technological relationship—indeed, the words “primary” and “secondary” could generally be substituted for “master” and “slave”—and is not intended to carry any connotation with respect to human slavery. Generally speaking, and as will be explained further in context below, any combination of the following may be true: a master device can send control signals or instructions to a slave device; a slave device may perform functions for or on behalf of a master device; a slave device may be synchronized to a master device; and a master device may have an enhanced status with respect to a slave device—with for example greater privileges, more processing power, more electrical power, more protection, more security or more functionality.)

In some embodiments, additional processing power may be provided to the headset wire in order to perform calculations inside the headset such as for active noise cancellation.

In FIG. 1, the least two microphones 26a and 26b may be digital microphones, for example, an Electret Condenser Microphone (ECM) with a built-in analog-to-digital (A/D) converter or a microelectromechanical system (MEMS) digital microphone and are able to pick up acoustic signals from the ambient environment. The at least two microphones 26a, 26b may then relay information or digital signals to the master device 20, via the slave device 18. If the at least two microphones 26a, 26b are of digital type, the slave device may include decimators to decrease the bandwidth required for transmitting the audio information. If the at least two microphones are analog microphones, the slave device 18 may digitize the signal before transmitting the signal to the master device 20 over the bus 16.

The slave device 18 may combine multiple digital sources and output the resulting digital acoustic information onto the bus 16. The digital acoustic information may then be received and processed by the master device 20 in the portable electronic device 12. The master device 20 is preferably implemented within the portable electronic device so as to provide the master device with greater processing power. By accessing the portable electronic device 12 to operate the master device, the headset 10 may be able to provide noise suppression or active noise cancelling, which may optimize the audio performance of the headset since the processing of signals is performed on the portable device rather than by the headset. This can be used to provide customized low latency audio solutions for active noise cancellation.

A ground potential may be shared between the earphones 24 and digital circuits of the slave device 18 and at least two microphones 26. In this context, a ground is not necessarily earth potential, and a “ground line” need not be electrically connected to the Earth. Rather, ground basically connotes a node that is maintained at a reference voltage that is substantially constant with respect to other voltages. There may be some modulation of the ground line due to external noise or ground currents. In order that this modulation does not result in excessive noise, it may be beneficial to use special modulation schemes, that reduce in-band audio noise such as digital data with low spectral content in the audio band or to actively reduce this influence, for example, by using a current-controlled speaker amplifier that compensates for ground noise. In some embodiments, the earphones 24 may be composed of a combination of passive components such as resistors, capacitor and inductors in order to present a stable load to a current controlled amplifier or to enable division of multiple audio bands in the headphone such as bass, mid-tone and tweeter. In other embodiments, the spectral content in the audio band may be reduced considerably by using out-of-band communication signals such as frequency encoding of digital data.

A third microphone 26c may be used to pick up audio signals such as speech. This microphone 26c may be used as a voice microphone and positioned at a location where it is able to accurately pick up audio signals when the headset 12 is in use. In one embodiment, the microphone 26c is positioned in proximity to a user's mouth in order to receive higher voice quality. This additional microphone 26c also allows the headset to be used during phone calls or for voice activation commands.

A capacitor 28 is included in the digital headset 10 shown in FIG. 1, and may be connected to the slave device 18 in order to store excess power that may be received through the bus 16. The capacitor 28 may further supply this stored power to the slave device 18 where higher power is required by the slave device 18 or to provide power to the other components of the headset. It can also be used to supply power if the slave device 18 receives intermittent power from the portable electronic device. An advantage of the capacitor is that if it is able to hold a charge to operate the slave device 18, the headset 10 may not require a further power source, such as a battery. Other known components for headsets may be reduced or eliminated as there may no longer be needed, such as, but not limited to, A/D converters, digital signal processing (DSP), interface circuitry, or a battery, etc. In cases where more power is needed than is available over the single wire bus, one wire or pin connection can be reserved to supply additional power.

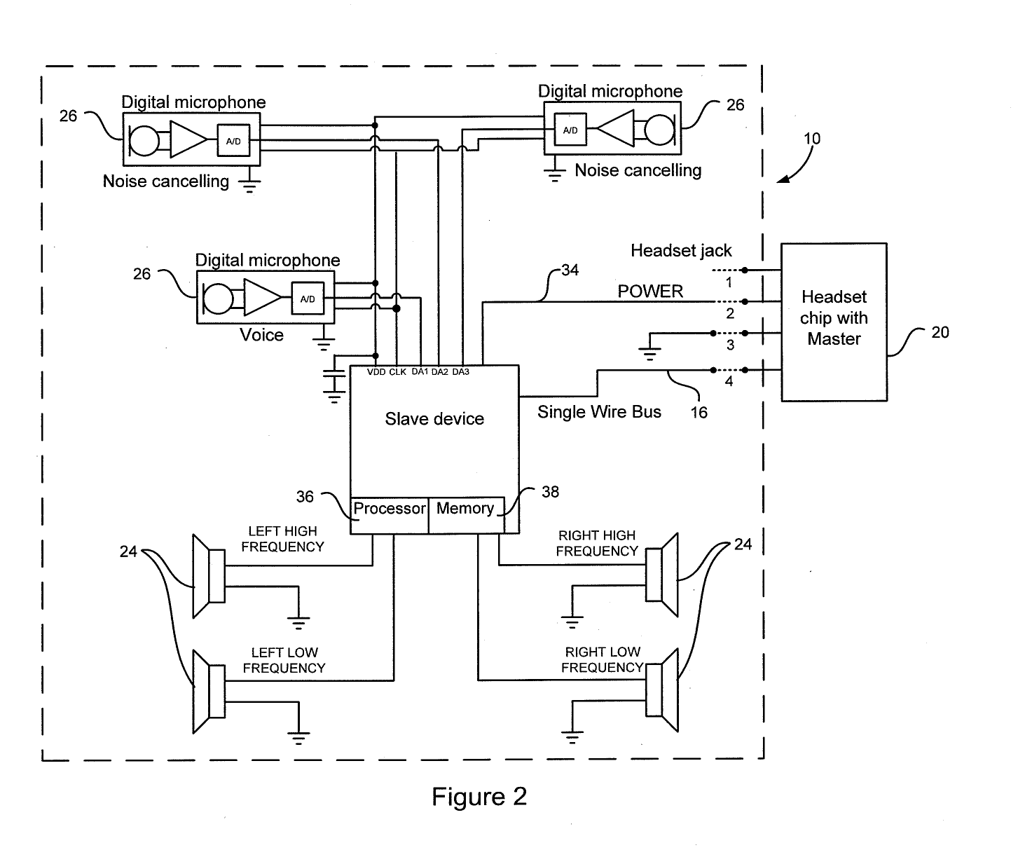

FIG. 2 illustrates another embodiment where the slave device 18 receives power though one pin connection 34 with the master device 20. The slave device 18 contains a processor 36 for providing processing power for tasks such as beam forming, active noise cancellation or audio stereo widening, which are intended to enhance the user experience of the headset without relying on the processing power and fixed algorithms available through the master device 20. The slave device 18 includes a memory element 38, which may allow the slave device 18 to store headset parameters, for example filter coefficients or electrical voltage to sound pressure level coefficients that may be preprogrammed during manufacturing of the headset. The filter coefficients may be available to the slave device or to the master device or both. The filter coefficient may be read using special commands. In some cases filter coefficients may be changed by the master. In other cases they may be fixed or a unique headset ID may be used to indicate the desired tuning parameters. In some cases, a first slave device 18 may be used for active noise cancellation and a second slave device (not shown) may perform additional tasks. The slave devices may be connected or in any other configuration.

FIG. 2 further illustrates two audio output elements per earphone 24 of the digital headset, where one speaker audio output element is dedicated to high frequencies while another audio output element is dedicated to low frequencies. This configuration may be used for high end advanced headsets where the use of two or more acoustic or audio output elements per channel enables a better listening experience. The use of multiple drives enables improved functionality with lower power consumption and lower noise. The slave device 18 may control each audio output element individually, by one or more amplifiers and one or more filtering elements, which may be either passive or active filtering elements. The active filtering element may be implemented using analog or digital signal processing. The filtering may be implemented within the slave device while the filter coefficients may be fixed inside the slave, updated individually or selected from a subset by the master.

In this embodiment, active noise cancellation may be processed through the slave device 18, although, as the slave device 18 may have less processing power than the master device 20, this arrangement may be less efficient. An advantage of placing processing power inside the slave device 18 may be that a headset can be updated more frequently and may use newer technology than the master device 20. Having a processor 36 incorporated into the slave device 18 may also reduce the need for extra processing power to be placed at the master device side. Furthermore, by placing the active noise cancellation inside the headset, the required bandwidth between the headset and the master device will be lower, thereby allowing lowering power consumption. It should also be noted that an oversampled signal may be necessary for low latency signal processing furthermore stressing the need for direct processing inside the headset.

The slave device 18 included within the digital headset 10 may receive signals from internal components, such as a chip supporting the communications protocol of the portable electronic device 12. The master device 20 inside the portable electronic device may provide synchronization, control and data to the headset 10. This arrangement may enable the slave device 18 to lock onto the bus 16 to receive or transmit audio data from or to the portable electronic device 12. Furthermore, the inclusion of control data allow specific device parameters from the headset 10 such as sensitivity, gain or filter co-efficients to be transferred between the portable electronic device 12 and headset 10. This arrangement may include safety mechanisms, where the user may be protected against excessive playback levels by the slave device 18 transferring headset parameters that are stored in the memory component 38. The master device 20, on retrieving those parameters, may determine the absolute sensitivity of the headset and may tune the output from the portable electronic device according to the headset parameters, thereby allowing custom parameters to be used. These playback levels and headset parameters may be stored as fixed coefficients or may be updated dynamically by either the master device 20 or the slave device 18.

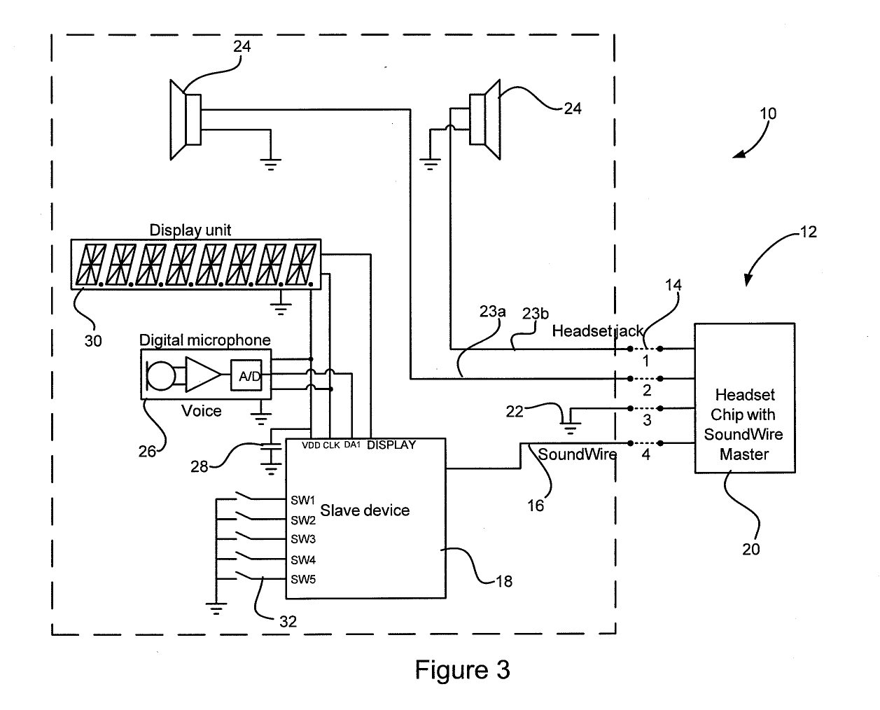

In an alternative embodiment, as schematically shown in FIG. 3, the headset 10 further comprises a display unit 40 in addition to the microphone 26 and audio output elements 24. The microphone 26 may be used as a voice microphone, for telephone calls or for inputting voice commands. The display unit 40 may be a monochrome display, which may receive information to display from the master device 20 located in the portable electronic device 12 via the bus 16 and slave device 18. The display 40 may be a visual prompt as to what song the portable electronic device 12 is currently playing, how long or how much time is left in the song, or may be used as a call display for an incoming call. The use of a monochrome display 40 allows for information to be communicated to a user without high power consumption. A colour or more graphical display may be used but may require the headset 10 to have a separate power source in order to meet the higher power requirements.

In this embodiment, the slave device 18 may transmit and receive the digital information such as clock, data and synchronization signals. Data is transferred from the master device 20 via the bus 16 to the slave device 18, which may further process the information prior to transmitting the information to the display 40. The slave device 18 may further include switches 32, which may be associated with buttons or other input means that would allow a user to access basic functionality via the headset. In one example, there could be provided a play/pause, forward, back and volume control buttons for use with a music application. There may also be buttons that may allow a user to answer a telephone call or resume music playing after a telephone call is completed. The buttons for music functionality and the buttons for phone functionality may be the same buttons with the processor controlling the buttons based on the application being executed or may be two separate sets of buttons. Other input configurations are contemplated. Buttons or switches may further be provided when there is no display, and may be used for similar applications or may be utilized as speed dial or other commands. The depressing of a switch (via an associated button) may result in the temporary shorting of the microphone terminals thereby indicating a button has been pressed.

The slave device 18 may include logical inputs for switches. The switches may allow for user input devices, for example, buttons, that may allow a user to change the volume of the headset, or answer a telephone call or allow for preset speed dial functionality, with input from the headset and not requiring extra input through the portable electronic device. In some embodiments, the switches may provide information about the pressure that is being applied to the switch.

The slave device 18 receives data from and transmits data to each of the microphones or display components and may further receive timing information through a clock connection. The slave may be used to setup specific gain or bias voltages inside the microphones or to read the specific sensitivity of each microphone.

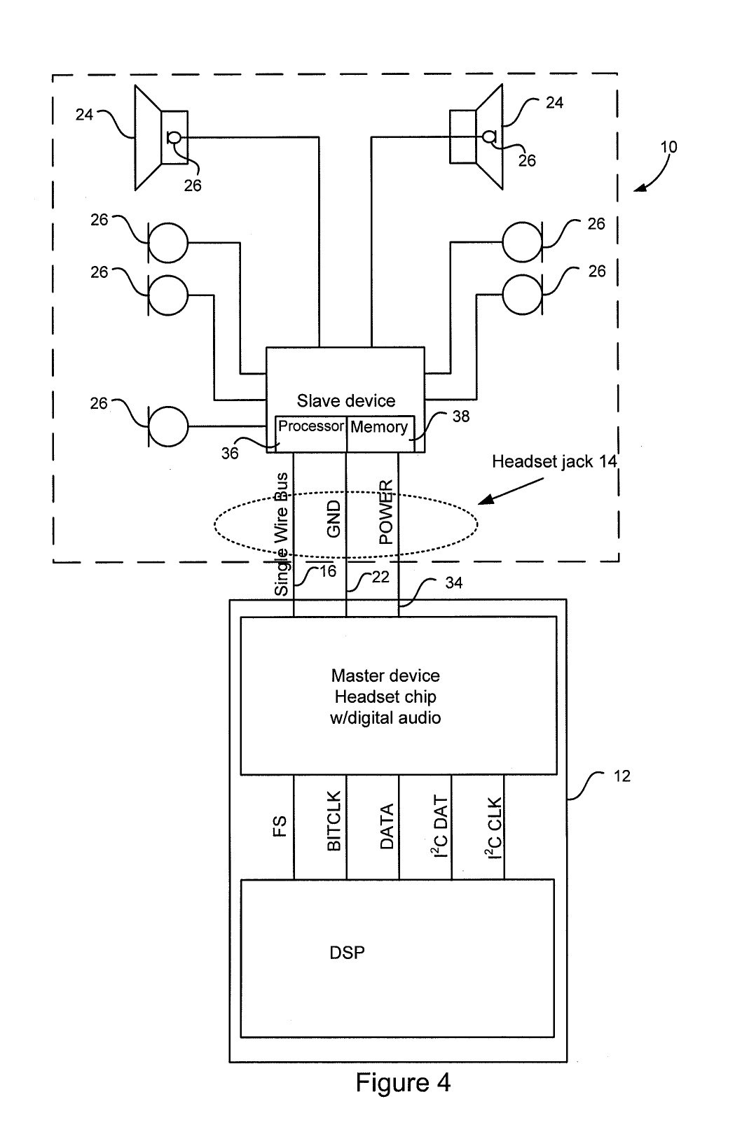

FIG. 4 illustrates another embodiment of a digital headset. In this embodiment, the active noise cancellation may be performed by the processor 36 of the slave device 18. The headset may include a plurality of digital microphones 26 which may measure the noise level by having one digital or analog microphone 26 inside one of the earphones 24 and measure the ambient noise level with a second digital or analog microphone 26 mounted outside the earphones 24. This arrangement can feed the noise levels to the slave device 18 and the slave device 18 may use either feedforward and feedbackward algorithms in order to perform active noise cancellation. A feedbackward algorithm will normally be used in an implementation where only a limited bandwidth of the noise cancellation is necessary (e.g. low frequency active noise cancellation such as airplane noise). In this case a single microphone inside the headset will be used. In order to use a feedforward algorithm either accurate calibration or an extra microphone may be necessary (located outside the headset and functioning as reference). This can enable wider band active noise cancellation but requires accurate calibration that may cause problems with long term stability or a combination of these algorithms to perform the active noise cancellation. After measuring the noise level, an anti-sound signal is calculated based on either fixed coefficients or adaptive filtering and sent to the earphones thereby significantly attenuating the level of noise heard by the listener. An advantage of adaptive filtering may be that it can take changes in the sensitivity and frequency response of the transducers into account, but the use of adaptive filtering may require more microphone elements. In some instances feedbackward and feedforward cancellation may be combined. Typically, to adapt to changing environments and transducer changes, it may be preferred to have a microphone next to the earphone and a microphone outside, though for some embodiments and for low cost implementations, only a single microphone may be used in some headset configurations and use only feedbackward compensation.

Once the acoustic signals have been processed to produce the noise cancellation affect, the signals may be transmitted to an audio output device such as the speaker element 24.

The slave device 18 may also have logic pre-programmed and stored in the memory component 38. The logic may include the functionality to determine a synchronization pattern received from the master device 20 and to transfer digital information to the master device 20 at either a certain timing range or at a certain frequency range. The slave device 18 may receive the synchronization pattern and data from the master device 20. Once a specific synchronization pattern has been found and verified, the slave device 18 may lock on to the bus 16 and notify the master device 20 within the portable electronic device 12 that the slave device 18 is attached to or ready for communication over the bus 16 or both. In order to distinguish between the synchronization pattern and random audio data it is possible to implement a synchronization pattern as a combination of a fixed entity and a dynamic entity, e.g. a pseudorandom counter. This way, the slave can quickly search for and find the fixed constant contained in the synchronization pattern and verify the correct position by the pseudorandom data. This also reduces the likelihood that the slave locks onto random static data on the bus. After synchronization has been established between the slave device and master device, the slave device may notify the master device that it is present and available. Then the master device 20 may set up communication of control and audio data between the two devices, the master device 20 and the slave device 18. This communication may take place over a single wire bus, where the clock is defined by a rising or falling signal edge, while the data is encoded by modulating the opposite (falling or rising) edge. The data may be read on either the rising of falling bit clock. In one example, the bit clock timing may depend on the number of channels used. However, it is also possible to implement this communication using more than a single wire, in which case the clock and data would typically be allocated over a separate line or pin connection. In other embodiment, the synchronization can be simpler and implemented like in simple serial interfaces like RS-232C, where no clock is transmitted and a stop and start bit is used to signal the end and start of a new block of information. This may also be used with frequency signaling schemes in order to provide inaudible two-way communication on the same wire as an analog signal, such as the microphone line.

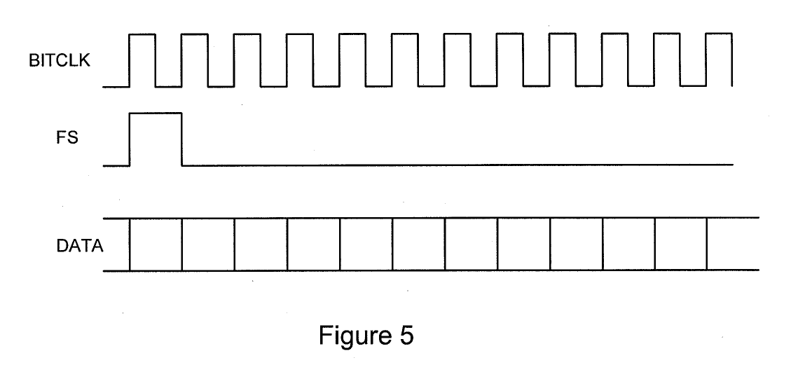

FIG. 5 illustrates an example of a digital signal processing (DSP) signals between a master device and the slave device wherein the frame signaling (FS) is either in BIT position 0 or 1.

The audio data may either be transferred between the master device 20 and the slave device as binary audio words as, for example, 16 bits or as an oversampled bit stream such as the output from a digital microphone or as a combination of these signals. The advantage of the bit stream format is that the latency is low and therefore well suited for active noise cancellation and beamforming applications. Also, the complexity at the transmitting side may be smaller. The synchronization and control data may furthermore be transferred in longer blocks, for example, 16 bits or interlaced in between the bit stream data for low latency applications. In some cases multiple streams of oversampled data may be multiplexed over a single wire and include control commands on this same wire by time-multiplexing the data streams and the synchronization/control. In some embodiments all communication or some channels may be encoded using strong encryption in order to protect intellectual property rights of audio recordings.

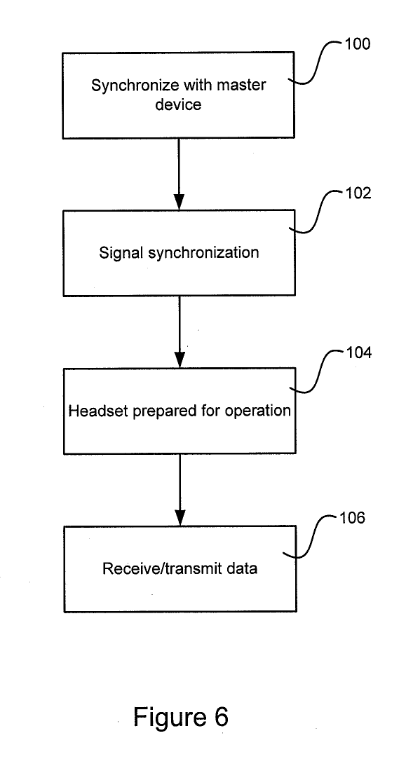

In a further embodiment, a method for processing and transferring signals to an advanced headset is provided as shown in FIG. 6. Once the portable electronic device 12 detects that a headset connector has been inserted into the headset connection 14 of the portable electronic device 12 an attempt to synchronize the slave device in the headset with the master device is initiated. Upon connection the master device 20 initiates a synchronization pattern or mechanism. The synchronization pattern may comprise a constant value or dynamic data or a combination thereof. The bus 16, which may be a single wire bus and may also supply power to the headset, will transfer the synchronization pattern from the master device 20 to the slave device 18. The synchronization pattern may either be by way of a timing algorithm or by frequency modulation such as inaudible frequency signaling. By establishing either separate timing or distinct frequencies for communication, the bus 16 may enable two way communication, using either a specific method of verifying the synchronization pattern such as implemented using a pseudo random timing sequence or using one frequency range for messages to the slave device and another frequency range for messages from the slave device 18 to the master device 20. After the slave device 18 has been synchronized to the master device, the slave device 18 may signal 102 that the slave device 18 is connected to the bus 16 and the master device 20 may then set up and control the slave device 18. In some configurations more than one slave device 18 may be connected to the bus 16 at the same time and may perform various functions which are intended to improve the listening experience for a user. If the slave device is not available, the master may look for other types of devices attached to the headset terminals or the master may use the opposite approach and first search for a predetermined set of accessories at the headset terminals and if none of the se are to be found then try to see if a slave device has been attached. The start of the search for an external device may be initiated by the opening of a switch at the headset port or by measurement of the change of an impedance between the terminal ports. The bus 16 may be adapted to use the time domain to transfer data between the master device 20 and the slave device 18. If a timing sequence synchronization pattern has been initiated, a constant value may be used by the slave device 18 to obtain fast synchronization while a pseudo random counter value may be used to verify the correct synchronization position in order not to synchronize the slave device 18 to the master device 20 at the wrong position in case random static data is present on the bus. Typically the pseudorandom sequence will be aligned at a certain specific distance from the constant value in order to verify the synchronization pattern. If the single wire bus is used and is adapted to use the frequency domain the master device will select the frequencies to be used by itself and the slave device 18 and the single wire bus will transmit this synchronization data to the slave device 18 so that the slave device 18 may transmit at the selected frequency, thus allowing for two-way communication. In this case, frequency signaling may be used by both the master device and the slave device. In yet another embodiment, two-way frequency signaling is used with out-of-band signals, in order to make this signaling inaudible. In some cases the synchronization may be instantaneous by using start/stop bits like a typical serial connection, but in this case the slave device may need its own clock source. The slave device 18 would normally receive the bus clock from the master device 20 in order to simplify hardware and reduce costs. This arrangement may be implemented over a single wire bus as mentioned earlier with alternate signal edges used for clock and data. In yet another embodiment, the slave device may generate an internal clock and use frequency variation as signaling or use the master device reference signal as reference for an oscillator, for the synchronization pattern. In some embodiments, the master shall transmit a constant frequency which the slave can use for synchronization purposes.

Once the synchronization pattern has been initiated by the master device and the slave device has been locked onto the bus, the digital headset is able to operate with an application, which may be selected by a user, or may be automatically initiated by the portable electronic device 12, for example receiving a call.

As the application is commenced, the single wire bus may allow data to be received or transmitted 106 between the master device 20 and the slave device 18. The single wire bus may allow for a more efficient method to transfer sound signals as compared to using bit stream signaling. By using a digital signal the sound may be more accurately represented as compared to analog encoding that is susceptible to noise and the digital data may be encoded as binary words and thereby less bandwidth than bit stream signals. For example, by encoding the data as binary words instead of bitstream signaling the bandwidth requirement is four times lower for 64 times oversampling and 16 bit binary words. If the headset includes the display 30, the master device may transmit data 106 to the slave device 18 in order to update the information shown on the display 30. Further, if noise cancellation is being processed by the master device 20, the slave may transmit data 106 received from the digital microphones 26 to the master device 20 for processing. In yet another embodiment, the active noise cancellation may take place within the headset, for example the slave device may take an active role in the noise cancellation in order to limit the number of signals sent to the master device, minimize the complexity of the headset arrangement and lower overall power consumption. Acoustic signals may further be transmitted to output devices such as earphones 24.

In another aspect, a method for determining digital headset sensitivity is provided. The slave device 18 may read 110 the headset coefficient that has been preprogrammed into the headset. For the earphone, the coefficient may be the conversion ratio from electrical voltage to acoustic or sound pressure level. For the digital microphone, this ratio may be the sound pressure level to full scale digital output. This coefficient may be stored in the memory component 38 as a headset parameter and may then be transferred to the master device 20. Once in receipt of this coefficient, the master device 20 may use associated software to adjust the volume for the speaker element by using analog or digital volume control to accurately calibrate downlink path and may further adjust the microphone input using analog or digital gain for the microphone or it may use this information for accurate calibration of uplink path. The input received by the headset 114 is therefore an adjusted input.

If multiple frequencies are used for calibration, the master device may further adjust the filter coefficients according to the sensitivities at these frequencies. By performing these adjustments, it is intended that the audio transferred to and played by the headset will be tuned for the headset in question. This adjustment may be performed when the digital headset 10 is inserted into the headset jack 14 and may not be required to be performed on a continuous basis. In some embodiments, the slave device will only receive or transmit digital audio data and perform the required frequency equalization itself.

In one embodiment of the digital headset, for a headset jack with four terminals or wires one connector or wire may be used for the single wire bus, and the remaining terminals or connectors may be free to be used for ground 22 and two audio output lines, which may be analog output lines, connected to the earphones 24 or for a separate power line and an additional clock/data line for a fully digital headset, or for a separate power line and a video connection. In some embodiments, the digital connection may be implemented using a ground and power connection and differential signaling that includes a continuous clock signal.

The bus 16 may perform further functions in addition to the connection to the digital headset. In one example, the bus 16 may be used to transfer digital audio to an external receiver, for example, a slave device that receives the digital audio data from the master device and converts the values to S/PDIF or other format. This arrangement can enable S-video connection and digital audio data over a limited four pin connection (digital data, ground, two video lines). In other embodiments, one pin may be used for composite video output simultaneously with digital audio. The digital bus may also be used with a ground and a power line and leave the last pin unused. In this case, the receiving end may contain both analog-to-digital and digital-to-analog converters in order to transform the digital information to the analog domain and may have the advantage that larger power can be transferred to the slave device through the dedicated power pin. The configuration of these connectors may vary without changing the overall scope of the digital headset.

In the preceding description, for purposes of explanation, numerous details are set forth in order to provide a thorough understanding of the embodiments of the invention. However, it will be apparent to one skilled in the art that these specific details are not required in order to practice the described embodiments. In other instances, well-known electrical structures and circuits are shown in block diagram form in order not to obscure the invention. For example, specific details are not provided as to whether the embodiments of the headset described herein are implemented as a software routine, hardware circuit, firmware, or a combination thereof.

The above-described embodiments of the headset are intended to be examples only. Alterations, modifications and variations can be effected to the particular embodiments by those of skill in the art without departing from the scope, which is defined solely by the claims appended hereto.

What is claimed is:

1. A headset for use with a portable electronic device comprising:
a headset jack;
a bus, located within the headset jack, for multiplexing digital information between the headset and the portable electronic device;
a slave device, connected to the bus, for processing, receiving and transmitting the digital information on the bus to the portable electronic device; and
at least one audio output device for transmitting an output based on the digital information.

2. The headset of claim 1 wherein the bus is a single wire bus.

3. The headset of claim 1 further compromising a digital microphone adapted to receive audio or voice signals.

4. The headset of claim 1 further comprising at least two digital microphones adapted to receive and transmit digital acoustic signals.

5. The headset of claim 4 wherein the at least two digital microphones are adapted to transmit the digital acoustic signals to the slave device for processing.

6. The headset of claim 5 wherein one of the at least two digital microphones is located within the at least one audio output device.

7. The headset of claim 1 further comprising a digital display.

8. The headset of claim 1 wherein the slave device comprises:
a processor; and
a memory component.

9. The headset of claim 1 wherein the digital information comprises a continuous clock signal.

10. The headset of claim 1 wherein the digital information comprises data to be output through the at least one audio output.

11. The headset of claim 1 wherein multiplexing digital information between the headset and the portable electronic device is in a time domain.

12. The headset of claim 1 wherein multiplexing digital information between the headset and the portable electronic device is in a frequency domain.
